(19) United States
(12) Patent Application Publication
(10) Pub. No.: US 2010/0109902 A1
(43) Pub. Date: May 6, 2010

(54) METHOD AND DEVICE FOR SYSTEM CONTROL

(75) Inventor: Marinus Johannes Gerdina Antonius Van Veghel, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 12/532,647

(22) PCT Filed: Mar. 26, 2008
(86) PCT No.: PCT/IB08/51125

§ 371 Date: Sep. 23, 2009

(30) Foreign Application Priority Data
Mar. 30, 2007 (EP) 07105283.1

(51) Int. Cl. G05B 19/02

(52) U.S. Cl. 340/825.22

(57) ABSTRACT

The invention relates to a communication device (101; 102; 103) for controlling a system is provided, the communication device comprising a reflecting element (111; 112; 113) for composing a system control command, wherein the composed system control command is comprised of light reflected by the reflecting element (111; 112; 113). The invention further relates to a receiver (200) for receiving the system control command composed by and comprised of the light reflected by the reflecting element (101; 102; 103) of the communication device, the receiver comprising a sensing unit (210) for sensing the light reflected by the reflecting element and a processing unit (220) for retrieving the system control command based on the light sensed by the sensing unit (210).

### FIELD OF THE INVENTION

The invention relates to the field of devices used by humans to control machines and in particular to passive communication devices.

### BACKGROUND OF THE INVENTION

A traditional device used by humans to control a system is a remote control. Remote controls are expensive, susceptible to mechanical shocks and exposure to moisture, and require electronic parts and a power supply. Another device used by humans to control a system is a pointing device. The pointing device may be used for pointing at a feature in an image displayed in a display. Pointing devices comprise a mouse and a trackball and may be used for controlling a personal computer, for example. Some systems are controlled using a touch screen for interacting with an image displayed on a display. Here the pointing device may be a finger or a stick. US patent application publication 2001/0030668, hereinafter referred to as Ref. 1, describes an embodiment of an apparatus comprising three hardware elements: a display, a light sensor or a camera that can register the display image and the pointing device or its effect on the display, and a pointing device that can be registered by or produces recognizable characteristics on the display that can be registered by the light sensor or camera. A limitation to using a pointing device such as described in Ref. 1 for controlling a system is that the device must interact with a display and/or a projector for displaying an image for controlling the system.

### SUMMARY OF THE INVENTION

It would be advantageous to have a device for controlling a system, which system does not need to interact with a display and/or a projector for displaying an image for controlling the system.

To address this concern, in an aspect of the invention, a communication device for controlling a system is provided, the communication device comprising a reflecting element for composing a system control command, wherein the composed system control command is comprised of light reflected by the reflecting element.

In a further aspect of the invention, a receiver for receiving the system control command composed by and comprised of the light reflected by the reflecting element of the communication device is provided, the receiver comprising:
a sensing unit for sensing the light reflected by the reflecting element; and
a processing unit for retrieving the system control command based on the light sensed by the sensing unit.

The light reflected by the reflecting element may be determined by a user operating the communication device, e.g., by suitably positioning the reflecting element. The light reflected by the reflecting element is sensed by the sensing unit of the receiver and obtained by the processing unit of the receiver. The sensing unit may comprise a light sensor or an array of light sensors, for example. The processing unit is arranged to perform an analysis of the sensed light comprising the light reflected by the reflecting element. The processing unit is further arranged to determine the system control command based on the analysis of the sensed light and to apply the system control command to the system.

In an embodiment of the communication device, the composed system control command is based on a position of the reflecting element. The position of the reflecting element, e.g., the angle between a reflecting surface and the direction of the incident light, may be determined by the user operating the communication device. The intensity of light reflected by the reflecting element and sensed by an array of light sensors of the sensing unit of the receiver may depend on the angle between a reflecting surface and the direction of the incident light. A first range of angles may correspond to a first system control command and a second range of angles may correspond to a second system control command.

In an embodiment of the communication device, the reflecting element comprises a retro-reflective surface. The advantage of using a retro-reflective surface is that it reflects the light in a direction substantially identical to the direction of an incident light beam. This allows reflecting the light towards the light source independent of the position of the reflecting element. Placing the sensing unit near the light source improves the ability of the receiver to sense the reflected light.

In an embodiment of the communication device, the communication device further comprises a shape determining means for determining the shape of the reflecting element. Different shapes of the reflecting element may correspond to different system control commands. The shape determining means thus allows composing different system control commands based on the shape of the reflecting element.

In an embodiment of the communication device, the communication device further comprises an identifier for identifying the communication device. This allows associating the composed system control command with the communication device based on said identifier. The system control command may thus be executed by the system if the identifier of the communication device satisfies a condition.

In an embodiment of the receiver, the sensing unit is further arranged for obtaining an image based on the light reflected by the reflecting element. The user may determine the light to be reflected by the reflecting element of the communication device, e.g., by positioning and/or by determining the shape of the reflecting element, thereby composing a system control command. The sensing unit may comprise a digital camera arranged to obtain an image based on the light reflected by the reflecting element. The processing unit may be arranged to analyze the image and to retrieve the system control command based on this image.

In an embodiment of the receiver, the retrieved system control command is based on the light sensed by the sensing unit at a plurality of time instances. For example, the user may move or change the shape of the reflecting element of the communication device. The light sensed by the sensing unit at a plurality of time instances may be analyzed by the processing unit. The processing unit may be arranged to retrieve the system control command based on the light sensed by the sensing unit at the plurality of time instances. Thus, the composing of the system control command may be based on the movement or changing shape of the passive control device.

In an embodiment of the receiver, the receiver further comprises a light source for emitting light to be reflected by the reflecting element of the communication device. The light may be harmless invisible radiation, e.g., infrared radiation. Further, the light may be modulated, e.g., emitted in pulses. This may further make the image processing by the processing unit more robust.

In a further aspect of the invention, a method of controlling a system is provided, which method comprises:
a composing step for composing a system control command, wherein the composed system control command is comprised of light reflected by a reflecting element of a communication device;
a sensing step for sensing the light reflected by the reflecting element; and
a processing step for retrieving the system control command based on the light sensed in the sensing step.

In a further aspect of the invention, a computer program product to be loaded by a computer arrangement is provided, the computer program product comprising instructions for controlling a system, the computer arrangement comprising a processor and a memory, the computer program product, after being loaded, providing said processor with the capability of retrieving a system control command composed by a reflecting element of a communication device based on a light sensed by a sensing unit of a receiver.

In a further aspect of the invention, an apparatus for manufacturing a control device is provided, which apparatus comprises means for manufacturing a reflecting element of the control device for composing a system control command, wherein the composed system control command is comprised of light reflected by the reflecting element.

It will be appreciated by those skilled in the art that two or more of the above-mentioned embodiments, implementations, and/or aspects of the invention may be combined in a useful way.

Modifications and variations of the method and/or of the computer program product, which correspond to the described modifications and variations of the communication device and/or receiver, can be carried out by a skilled person on the basis of the present description.

### BRIEF DESCRIPTION OF THE DRAWINGS

These and other aspects of the invention will become apparent from and will be elucidated with respect to the implementations and embodiments described hereinafter and with reference to the accompanying drawings, wherein:

FIG. 1 schematically shows two exemplary embodiments of the communication device;

FIG. 2 schematically shows an exemplary embodiment of the receiver;

FIG. 3 schematically shows two exemplary images obtained by the camera of the light sensing unit of the receiver;

FIG. 4 schematically shows a view of an exemplary identifier of the communication device;

FIG. 5 shows an exemplary embodiment of the communication device;

FIG. 6 shows an exemplary image obtained by the camera of the light sensing unit of the receiver;

FIG. 7 shows an exemplary embodiment of the sensing unit and the light source of the receiver; and

FIG. 8 shows a flowchart of an exemplary implementation of the method.

The same reference numerals are used to denote similar parts throughout the Figures.

### DETAILED DESCRIPTION OF EMBODIMENTS

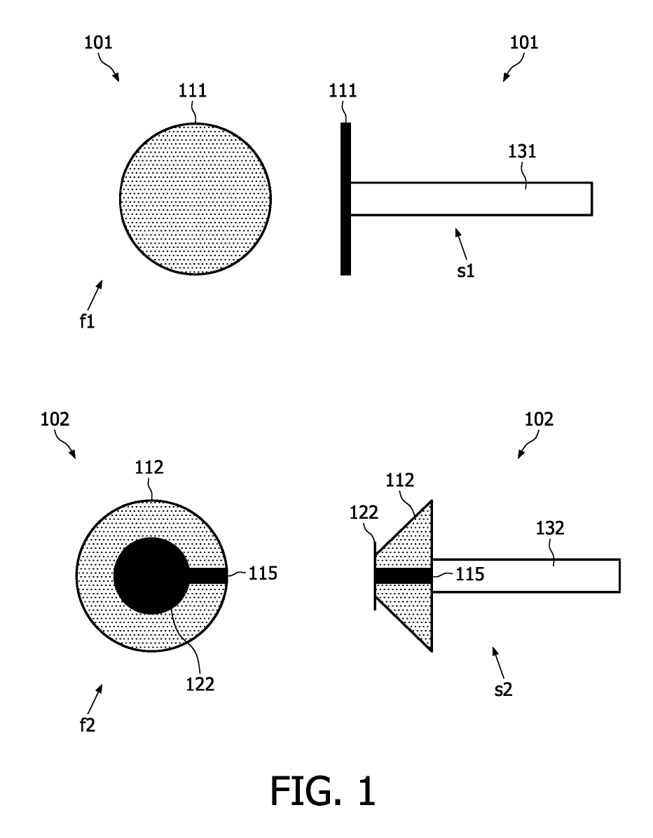

FIG. 1 schematically shows two exemplary embodiments of the communication device. The first picture f1 and the second picture s1 show a front view and a side view, respectively, of a first embodiment of the communication device 101. The device comprises a flat circular reflecting element 111 and a cylindrical grip 131. The axes of the flat circular reflecting element 111 and the grip 131 are substantially identical. The flat circular reflecting element 111 surface is made of a light reflecting material such as, but not limited to, an aluminum foil or a retro-reflective paint. The third picture f2 and the fourth picture s2 show a front view and a side view, respectively, of a second embodiment of the communication device 102. This embodiment comprises a reflecting element 112 in the form of a reflecting cap shaped as a cone with the top cut off, a circular cover 122 of the cap 112, and a cylindrical grip 132. The axes of the cap 112, the cover 122 and the grip 132 are substantially identical. The surface of the cap 112 is made of a light reflecting material such as, but not limited to, an aluminum foil or a retro-reflective paint and comprises a gap 115. The gap surface has substantially different reflecting properties from the rest of the cap surface, for example, the gap surface may be substantially non-reflecting.

The skilled person will understand that there are many possible embodiments of the communication device, which may differ, e.g., in the shape of the reflecting element and in the light reflecting properties of the materials comprised of the reflecting element and/or in the distribution of these materials on the surface of the reflecting element.

In an embodiment of the communication device, the reflecting element is covered by a thin film filter coating for transmitting light of a certain wavelength, e.g., the infrared light. An advantage of using infrared light is that infrared light is harmless and invisible to humans. Thus, the reflecting element may be arranged to reflect only the light of the certain wavelength. Moreover, the reflecting element will reflect the light only if the incident light beam comprises light of the certain wavelength. This feature may be used, for example, to assign a different wavelength to each passive control device for identifying which passive control device has composed the system control command on the basis of the wavelength of the reflected light. The skilled person will know other ways of implementing light filters. Using other optical filters and devices, e.g., dichroic filters, polarization filters, interference filters, prisms, half-wave plates and quarter-wave plates is also contemplated.

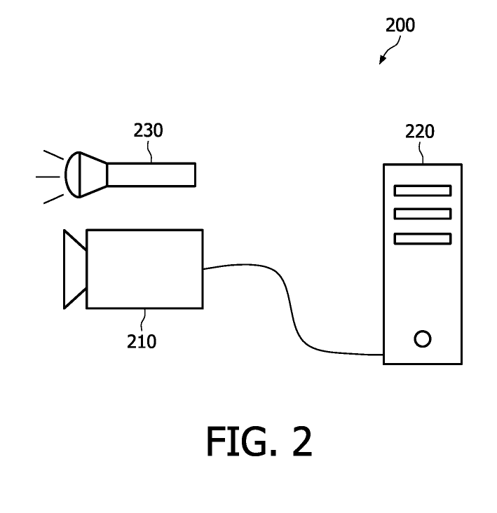

FIG. 2 schematically shows an exemplary embodiment of the receiver 200 for receiving the system control command composed by and comprised of the light reflected by the reflecting element of the communication device, the receiver comprising:
a sensing unit 210 for sensing the light reflected by the reflecting element; and
a processing unit 220 for retrieving the system control command based on the light sensed by the sensing unit 210.

The exemplary embodiment of the receiver 200 shown in FIG. 2 further comprises an optional light source 230 for emitting light to be reflected by the reflecting element of the communication device.

The processing unit 220 is arranged to analyze the light sensed by the sensing unit 210. The sensing unit 210 may comprise a light sensor using, for example a phototransistor or a photodiode, for sensing the intensity of incident light. The light sensed by the sensing unit 210 comprises the light reflected by the reflecting element of the control communication device. The processing unit 220 may be arranged to analyze the intensity of light sensed by the light sensor and to retrieve the system control command based on the analysis.

In an embodiment of the receiver 200, the sensing unit 210 is further arranged for obtaining an image based on the light reflected by the reflecting element. For example, the sensing unit may comprise a digital camera. The obtained image may depict the reflecting element. The image based on the light reflected by the reflecting element depends on the design and position of the communication device. The position is determined by the user holding the communication device. The image based on the light reflected by the reflecting element may further depend on the position of the sensing unit 210 and/or of the light sources illuminating the reflecting element and the sensing unit 210. The image based on the light reflected by the reflecting element is transferred to the processing unit 220. The processing unit 220 is arranged to analyze the image and to determine a system control command based on the image analysis using, for example, a look-up table where an image based on the light reflected by the reflecting element is assigned to a system control command. Optionally, the sensing unit 210 may have a color filter mounted on the lens to improve the contrast of the sensed light. The color filter may transmit light from a narrow band of wavelengths, e.g., from an infrared band, and block other light.

To improve the operation of the receiver, the processing unit 220 of the receiver 200 may employ an image processing algorithm for analyzing an image acquired by the sensing unit 210 comprised of the receiver 200. The image processing may include, but is not limited to, image filtering and/or time averaging of multiple images acquired by the sensing unit 210. Image filtering may be useful in eliminating image artifacts resulting from imperfections of and damage to the reflecting element of the passive control device, for example. The time averaging of multiple images may be useful for eliminating motion artifacts.

In an embodiment the receiver further comprises a light source 230 for emitting light to be reflected by the reflecting element of the communication device. The light source 230 may be located in any suitable position relative to the sensing unit. The light source 230 may be arranged to emit a light beam, e.g., a parallel light beam or a conical light beam. The position of the light source 230 or the size of the light beam, e.g., the radius of a cylindrical light beam or the conical angle of a conical light beam may be a design parameter of the receiver. Optionally, there may be a plurality of light sources. The light may be, in principle, any harmless electromagnetic radiation, e.g., infrared radiation or visible radiation. The light may be monochrome or may comprise a plurality of radiation frequencies. The light may be emitted parallel to the optical axis of the sensing unit 210, e.g., to the optical axis of the lens of a digital camera comprised of the sensing unit 210.

In an embodiment of the receiver 200, the light source 230 is arranged to emit light continuously. Alternatively, the light source may be arranged to emit light in light pulses. Emitting light in pulses may advantageously decrease the amount of energy used by and increase the lifetime of the light source 230. Further, emitting light in pulses may decrease the exposure of humans, e.g., operators of the communication devices, to the radiation. Another advantage of using light pulses is that illumination intensity of a light pulse may be much higher than the illumination intensity of a continuous light. The shape of each pulse may be determined by an electronic circuit comprised of the receiver 200. The sensing unit 210 may be synchronized with the light source.

In an embodiment of the communication device, the reflecting element comprises a retro-reflective surface. For example, the flat surface of the circular reflecting unit 111 or the conical surface of the cap of the reflecting unit 112 shown in FIG. 1 may be made of or covered by a retro-reflective material. Nowadays, retro-reflective materials are cheap and easily available. For example, 3M™ Scotchlite™ Photoelectric Grade Smooth Surface Sheeting available in tape rolls with adhesive and liner may be used. An advantage of using a retro-reflective material is that the direction of the reflected light is approximately the same as the direction of the incident light. Therefore, the light emitted from the source 230 located near the sensing unit 210 is reflected towards the sensing unit 210. Thus, the sensing unit 210 will sense the light reflected by the retro-reflective parts of the communication device illuminated by the light source 230, while the surrounding parts of the communication device may be designed and constructed in such a way that they do not reflect light. This significantly increases sensitivity and resolution of the receiver 200.

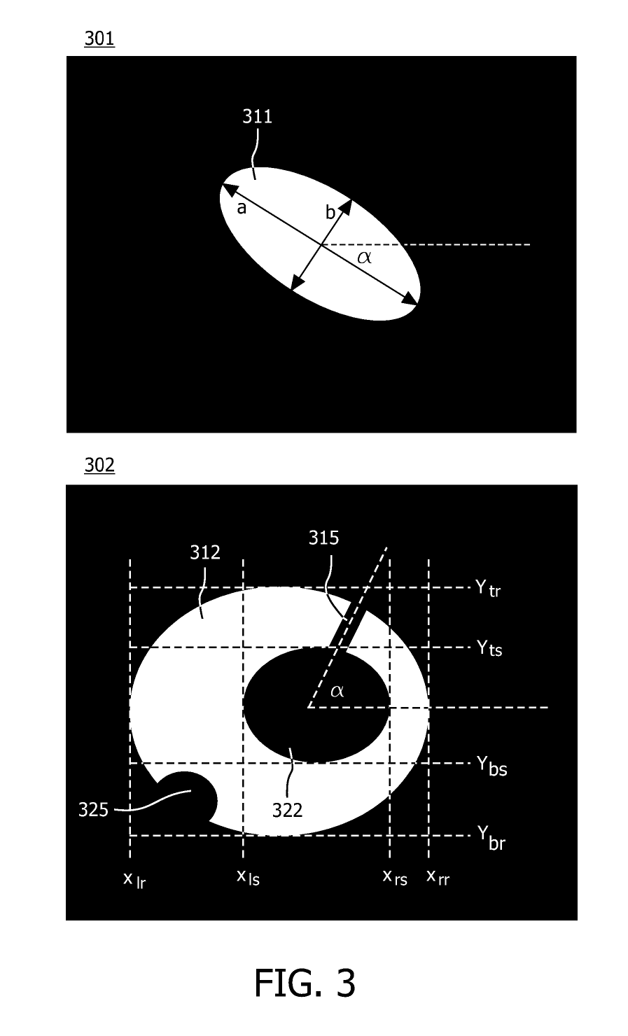

FIG. 3 schematically shows two exemplary images 301 and 302 obtained by the camera of the light sensing unit 210 of the receiver 200. The first image 301 corresponds to the first exemplary embodiment of the communication device 101 schematically illustrated in views f1 and s1 in FIG. 1. The flat circular surface 111 of the exemplary embodiment of the communication device 101 may be covered by a retro-reflective material. The receiver 200 comprises the light source 230 located near the camera of the light sensing unit 210. The image 301 comprises a reflection 311 of the circular surface 111. The shape of the reflection 311 of the circular surface 111 is an ellipse.

In an embodiment of the receiver 200, the retrieved system control command is based on the image 301 obtained by the camera of the light sensing unit 210 and analyzed by the processing unit 220. For example, the ellipse of the reflection 311 may be described by the ratio b/a of the length b of the shorter axis of the ellipse by the length a of the longer axis of the ellipse. The angle α is an angle between an x-axis of a coordinate system and the long axis a of the ellipse 311. The ratio b/a and angle α may be exemplary parameters of the image 301 obtained by the camera of the sensing unit 210. These exemplary parameters may be computed by the processing unit 220 of the receiver 200. The computed values of the ratio b/a and angle α may be used for obtaining a system control command based on an image 301. For example, the ratio b/a greater than a threshold may correspond to a first system control command and the ratio equal to or less than the threshold may correspond to a second system control command.

The second image 302 corresponds to the second exemplary embodiment of the communication device 102 schematically illustrated in views f2 and s2 in FIG. 1. The conical surface 112 of the exemplary embodiment of the communication device 102 may be covered by a retro-reflective material and the gap 115 may be made of a material that does not substantially reflect the light. The non-reflecting circular cover 122 may also be covered by a material which does not substantially reflect the light. The receiver 200 comprises the light source 230 located near the camera of the light sensing unit 210. The image 302 comprises a reflection 312 of the conical surface 112, a gap shade 315 of the gap 115, and a cover shade 322 of the circular cover 122. The shape of the reflection 312 of the conical surface 112 is an ellipse. The shape of the cover shade 322 of the circular cover 122 is also an ellipse. The size and orientation of the ellipses of the reflection 312 and of the cover shade 322 depends on the position of the communication device 102 relative to the light sensing unit 220. The image 302 shown in FIG. 3 comprises also a finger shade 325.

The ellipse of the reflection 312 may be described by an x-coordinate xₗᵣ of the leftmost point of the ellipse, by an x-coordinate xᵣᵣ of the rightmost point of the ellipse, by a y-coordinate yₜᵣ of the topmost point of the ellipse, and by a y-coordinate y_{br} of the bottommost point of the ellipse. Similarly, the ellipse of the cover shade 322 may be described by an x-coordinate xₗₛ of the leftmost point of the ellipse, by an x-coordinate xᵣₛ of the rightmost point of the ellipse, by a y-coordinate yₜₛ of the topmost point of the ellipse, and by a y-coordinate y_{bs} of the bottommost point of the ellipse. The point coordinates may be given in a coordinate system of the image 302, for example. α is an angle between the x-axis of the coordinate system and the direction of the gap shade 315 in the image 302.

Based on the image 302 obtained using the communication device 102, the following exemplary parameters of the light pattern may be computed by the processing unit 220 of the receiver 200:
the position of the center of the ellipse of the reflection 312 ((xₗᵣ−xᵣᵣ)/2, (yₜᵣ−y_{br})/2);
the position of the center of the ellipse of the cover shade 322 ((xₗₛ−xᵣₛ)/2, (yₜₛ−y_{bs})/2);
the size of the reflection 312 defined, for example, by the length of the major axis of the ellipse of the reflection 312;
the roll α;
the pitch yᵤᵣ+yᵤₛ−y_{br}−y_{bs}; and
the yaw xᵣᵣ+xᵣₛ−xₗᵣ−xₗₛ.

In an embodiment of the receiver 200, the retrieved system control command is based on an image obtained by the camera of the light sensing unit 210 and analyzed by the processing unit 220. For example, with further reference to FIG. 3, the analysis may involve computing the value of a parameter such as the position of the center of the ellipse of the reflection 312, the position of the center of the ellipse of the cover shade 322, the size of the reflection 312, the roll, the pitch or of the yaw. A function with a domain comprising the range of values of a parameter may map a value of the parameter into a system control command. For example, a function may map each convex angle α into a first system control command and each non-convex angle α into a second control command. Optionally, the function may depend on two or more parameters. For example, a function depending on the pitch and yaw may map a pair of pitch and yaw values into a first system control command if both values are positive, into a second system control command if the pitch value is positive and the yaw value is negative, into a third system control command if the pitch value is negative and the yaw value is positive, and into a fourth system control command if both values are negative. A finger shade 325 may be assigned a toggle on/off function for switching on or switching off the controlled system.

The skilled person will appreciate that there are many possible parameters and functions suitable for assigning a system control command to an image obtained by the camera of the light sensing unit 210. These parameters may be computed and used by the processing unit 220 of the receiver 200. The described parameters and functions illustrate the invention and must not be construed as limiting the scope of the claims.

In an embodiment of the receiver 200, the retrieved system control command is based on the light sensed by the sensing unit 210 at a plurality of time instances. The processing unit 220 may be arranged to analyze the change of light sensed by the sensing unit 210 at a plurality of time instances and to determine the system control command based on this analysis. For example, processing unit 220 may be arranged to analyze images obtained by the camera of the light sensing unit 210 of the receiver 200 at the plurality of time instances. The user may move the passive control device towards or away from the sensing unit 210 thereby increasing or decreasing, respectively, the size of the reflection 312 in the image 302. Increasing the size of the reflection 312 with a speed greater than a speed threshold may be mapped into a first system control command. Decreasing the size of the reflection 312 with a speed greater than the speed threshold may be mapped into a second system control command. When the size of the reflection 312 does not change or when it changes at a speed equal to or less than the speed threshold, no system control command is retrieved by the processing unit 220.

The skilled person will appreciate that the communication device may be designed and manufactured in such a way that it is light, cheap in terms of labor and material cost, robust, fluid-damage resistant, ergonomic, and/or sterile. The device may be disposable. For example, the apparatus comprising the communication device and the receiver 200 may be used by a patient who wants to control a system such as a television set from her/his bed, or by a surgeon who needs to control a surgery navigation system for displaying anatomical images of an organ on which the surgeon operates. The device may be designed and manufactured for use in different conditions, e.g., for use indoor, outdoor, under water, at various, even extreme, temperatures and humidity levels.

All electronic components of the apparatus for controlling a system, the apparatus comprising the communication device and the receiver 200, may be present in the receiver 200. Thus, the device may require no electronic parts and/or a power supply.

In an embodiment of the apparatus for controlling a system, the sensing unit 210 of the receiver 200 is arranged to sense light originating from a limited area, and/or the light source 230 is arranged to illuminate a limited area. This allows many users at the same location to control their systems without interfering with each other. For example, each patient may operate her/his own television set from her/his bed without interfering with a television set of another patient. Further, each light source 230 may employ a unique wavelength and/or pulse shape or frequency of the light emitted from the light source 230. Optionally, each communication device may be marked by an identifier, e.g., an alphanumerical symbol, a bar code or a dot code, comprised of the reflecting element of the device. Alternatively, the shape of the reflecting element of the communication device may play the role of an identifier with different users using reflecting elements of different shapes.

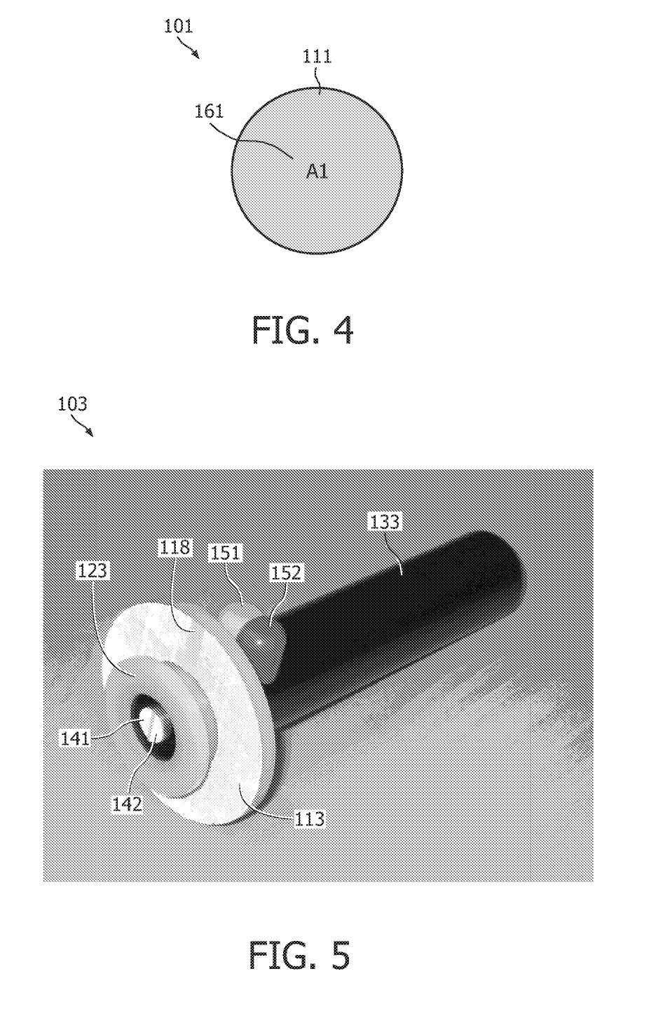

FIG. 4 schematically shows a view of an exemplary identifier 161 of the communication device 101. The exemplary identifier 161 marks the reflecting unit 111 with a non-reflecting alphanumeric symbol. The information about the identifier is comprised of the light reflected by the reflecting element of the device. The light reflected by the reflecting element is sensed by the sensing unit 210 of the receiver 200. The processing unit 220 of the receiver 200 is arranged to retrieve the identifier from the sensed light. If the retrieved identifier satisfies a condition, e.g., if the retrieved identifier is identical to an identifier stored in the processing unit 220, a system control command comprised of the light reflected by the reflecting element of the device is retrieved by the processing unit 220 of the receiver 200. Otherwise, a further processing or no further processing of the light sensed by the sensing unit 210 is performed by the processing unit 220 of the receiver 200. For example, the processing unit 220 may be arranged for checking whether the identifier satisfies a further condition. The further condition may be verifying whether the retrieved identifier is identical to a further identifier stored in the processing unit 220. For example, the identifier may be an identifier of an individual user, e.g., a patient, and the further identifier may be an identifier of an administrator of the system, e.g., a nurse. Optionally, the further processing my include locking the system, which can be unlocked only by using the communication device with a proper identifier.

Although the embodiments of the invention are described in relation to medical applications such as in relation to a device for controlling a television set by a patient or a surgery navigation system for use by a surgeon, the skilled person will understand that other applications of the invention may also be contemplated. For example, it is possible to use retro-reflective labels as communication devices, to label items in a dispatch system for routing said items to proper destinations. Each label may comprise an identifier and a command to the dispatch system. The apparatus comprising the label and the receiver may be arranged to illuminate the label of an item, sense the reflected light, obtain the identifier, obtain the command for the dispatch system based at least on the identifier, and send the command to the dispatch system. The dispatch system may be arranged to process the item based on the obtained item-specific command.

FIG. 5 shows an exemplary embodiment of the communication device 103. The surface of the ring of the reflecting element 113 is covered by a retro-reflective tape. The ring of the reflecting element 113 comprises a narrow radial gap 118 which is not covered by the retro-reflective tape. To enable composing many mutually different system commands by setting the pitch and/or yaw of the exemplary device 103, the front ring of the cover 123 is placed at some distance from the ring of the reflecting element 113.

The exemplary embodiment of the communication device 103 shown in FIG. 5 further comprises two semicircles 141 and 142. The surface of each semicircle is made of a retro-reflective material. The grip 133 of the device further comprises two pushbuttons 151 and 152. The lighter pushbutton 151 moves the first semicircle 141 away from the axis of the exemplary device. The darker pushbutton 152 moves the second semicircle 142 away from the axis of the device. The buttons 151 and 152 and the semicircles 141 and 142 may be used to implement further control commands, for example a click command for controlling a pointer on a display of the controlled system.

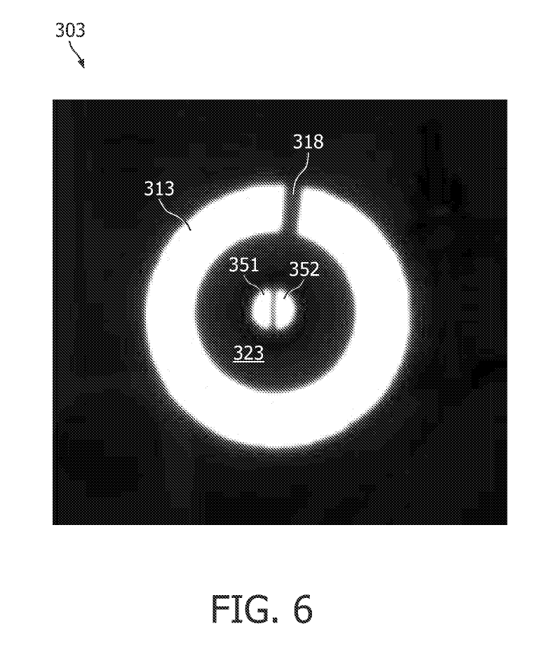

FIG. 6 shows an exemplary image 303 obtained by a camera of the light sensing unit 210 of the receiver 200. The exemplary image 303 has been obtained using the exemplary embodiment of the communication device 103 shown in FIG. 5. The image 303 comprises a reflection 313 of the reflecting element 113 of the exemplary device 103, the gap shade 318 of the gap 118, the cover shade 323 of the cover 123, and two semicircular reflections 341 and 342 of the semicircles 141 and 142, respectively.

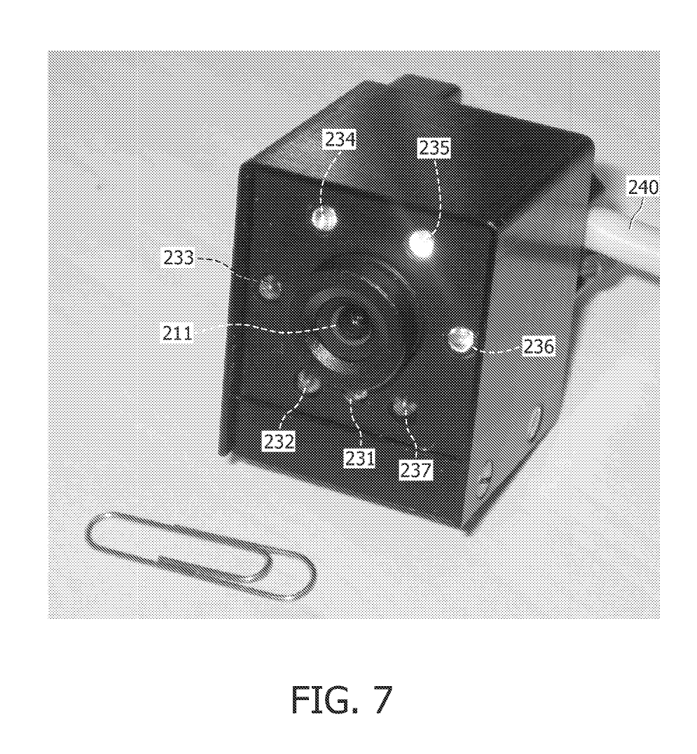

FIG. 7 shows an exemplary embodiment of the sensing unit and light source of the receiver. The exemplary embodiment of the sensing unit comprises a digital camera with a lens 211. An image recorded by the camera is transferred to the processing unit via a connection comprised of a cable bundle 240. The skilled person will understand that, alternatively, the data may be transferred via any other connection, e.g., via a wireless connection. Optionally, the processing unit may be integrated with the digital camera of the sensing unit and the light source.

The exemplary embodiment of the light source comprises seven light-emitting diodes (LEDs) 231 to 237. The beam volume of the first LED 231 is arranged to illuminate a first area around the optical axis of the lens 211. The six remaining LEDs 232 to 237 illuminate areas adjacent to the first area. The distance between the lens and the surface of the reflecting element of the communication device should guarantee that the surface of the reflecting element is adequately illuminated by the LEDs and that the resolution of the images captured by the camera is sufficient for interpreting the images and thereby for the processing unit to retrieve the system control command. A practical working distance range for the camera of the light sensor and for the light source shown in FIG. 7 is 20 cm to 5 m. The skilled person will understand that this range may be different in other embodiments of the invention.

In an embodiment of the communication device, the reflecting element is a mirror. For example the reflecting element may be a convex mirror such as a half-sphere. A convex half-sphere mirror reflects a parallel beam of light in all directions. Thus, there is substantially no restriction on the position of the light source 230 as long as the convex half-sphere mirror is illuminated by the light source 230. Optionally, multiple light sources may be used to ensure that the mirror is sufficiently illuminated. Alternatively, no dedicated light source is necessary and an existing light source, e.g., natural daylight, may be used. The convex half-sphere mirror may be turned towards the light sensor and away from the light sensing unit 210 of the receiver 200. The light sensing unit 210 is arranged to periodically measure the intensity of light. The light sensing unit may use a single light sensor such as a phototransistor. A sequence of measurements is interpreted as a system control command if the sequence satisfies a predetermined condition. Otherwise the sequence of measurements is ignored.

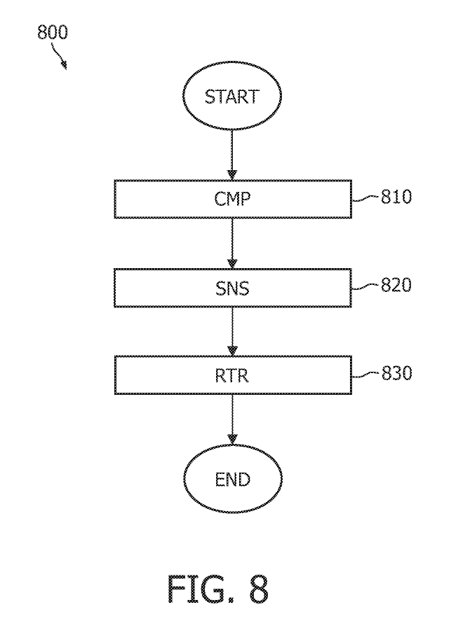

FIG. 8 shows a flowchart of an exemplary implementation of a method 800 of controlling a system. The method 800 begins with a composing step 810 for composing a system control command, wherein the composed system control command is comprised of light reflected by a reflecting element of a communication device. After the composing step 810, the method 800 continues to a sensing step 820 for sensing the light reflected by the reflecting element. After the sensing step 820, the method 800 continues to a processing step 830 for retrieving the system control command based on the light sensed in the sensing step 820. After the processing step 830, the method 800 ends.

It should be noted that the above-mentioned embodiments illustrate rather than limit the invention and that those skilled in the art will be able to design alternative embodiments without departing from the scope of the appended claims. In the claims, any reference signs placed between parentheses shall not be construed as limiting the claim. The word “comprising” does not exclude the presence of elements or steps not listed in a claim or in the description. The word “a” or “an” preceding an element does not exclude the presence of a plurality of such elements. The invention may be implemented by means of hardware comprising several distinct elements and by means of a programmed computer. In the system claims enumerating several units, several of these units can be embodied by one and the same item of hardware or software. The use of the words first, second, third, etc. does not indicate any particular sequence. These words are to be interpreted as names.

1. A communication device (101; 102; 103) for controlling a system, the communication device comprising a reflecting element (111; 112; 113) for composing a system control command, wherein the composed system control command is comprised of light reflected by the reflecting element.

2. A communication device (101; 102; 103) as claimed in claim 1 wherein the composed system control command is based on a position of the reflecting element (111; 112; 113).

3. A communication device (101; 102; 103) as claimed in claim 1 wherein the reflecting element (111; 112; 113) comprises a retro-reflective surface.

4. A communication device (101; 102; 103) further comprising a shape determining means (141; 142; 151; 152) for determining a shape of the reflecting element.

5. A communication device (101; 102; 103) further comprising an identifier (161) for identifying the communication device.

6. A receiver (200) for receiving a system control command composed by and comprised of light reflected by a reflecting element (111; 112; 113) of a communication device (101; 102; 103) as claimed in claim 1, the receiver (200) comprising:
a sensing unit (210) for sensing the light reflected by the reflecting element; and
a processing unit (220) for retrieving the system control command based on the light sensed by the sensing unit (210).

7. A receiver (200) as claimed in claim 6, wherein the sensing unit 210 is further arranged for obtaining an image (301; 302; 303) based on the light reflected by the reflecting element (111; 112; 113).

8. A receiver (200) as claimed in claim 6, wherein the retrieved system control command is based on the light sensed by the sensing unit (210) at a plurality of time instances.

9. A receiver (200) as claimed in claim 6 further comprising a light source (230) for emitting light to be reflected by the reflecting element (111; 112; 113) of the communication device (101; 102; 103).

10. A method (800) of controlling a system, the method comprising:
a composing step (810) for composing a system control command, wherein the composed system control command is comprised of light reflected by a reflecting element of a communication device;
a sensing step (820) for sensing the light reflected by the reflecting element; and
a processing step (830) for retrieving the system control command based on the light sensed in the sensing step (820).

11. A computer program product to be loaded by a computer arrangement, the computer program product comprising instructions for controlling a system, the computer arrangement comprising a processing unit and a memory, the computer program product, after being loaded, providing said processing unit with the capability of retrieving a system control command composed by a reflecting element (111; 112; 113) of a communication device (101; 102; 103) based on a light sensed by a sensing unit of a receiver (200).
